(19) United States
(12) Patent Application Publication
(10) Pub. No.: US 2015/0048997 A1
(43) Pub. Date: Feb. 19, 2015

(54) ANTENNA MODULE AND WIRELESS COMMUNICATION DEVICE USING SAME

(71) Applicant: FIH (Hong Kong) Limited, Kowloon (HK)

(72) Inventor: CHI-SHENG LIU, New Taipei (TW)

(73) Assignee: FIH (HONG KONG) LIMITED, Kowloon (HK)

(21) Appl. No.: 14/221,553

(22) Filed: Mar. 21, 2014

(30) Foreign Application Priority Data
Aug. 13, 2013 (TW) 102129064

(51) Int. Cl. H01Q 9/04

(52) U.S. Cl. CPC H01Q 9/0442
USPC 343/904

(57) ABSTRACT

An antenna module includes an antenna, a number of conductive elements, and a connecting element. The conductive elements and the connecting element are made of conductive material. The conductive elements are adjacent to the antenna, and the connecting element allows for the connection of different numbers of the conductive elements to the antenna depending upon the desired working frequency for the antenna to increase a current length of the antenna.

### BACKGROUND

1. Technical Field

The disclosure generally relates to antenna modules, particularly to an antenna module having adjustable working frequencies and a wireless communication device using the same.

2. Description of the Related Art

Antennas are usually assembled in a wireless communication device to send and/or receive signals. Commonly, frequencies of the antennas are adjusted according to different communication requirements by matching circuits disposed on a circuit board of the wireless communication device. However, the matching circuits make structures of the circuit board more complex and expensive.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 shows an exploded, schematic view of an exemplary embodiment of a wireless communication device having an antenna module.

FIG. 2 shows an assembled schematic view of the wireless communication device of FIG. 1.

FIG. 3 is similar to FIG. 2, but shown from another angle.

FIG. 4 is a diagram showing return loss measurements of the antenna module of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

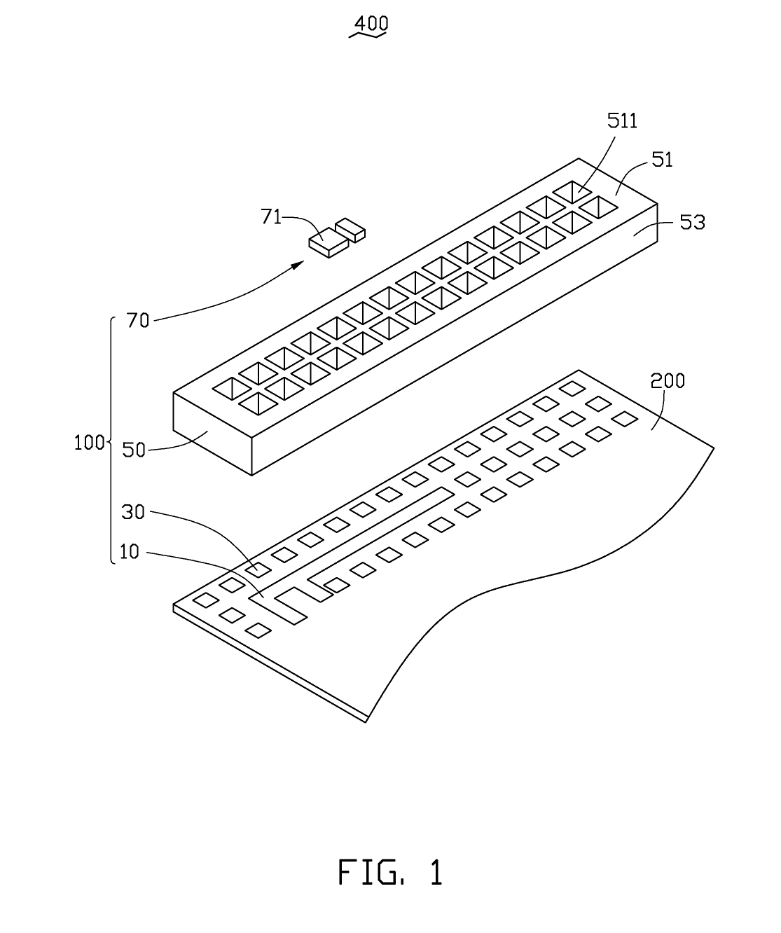

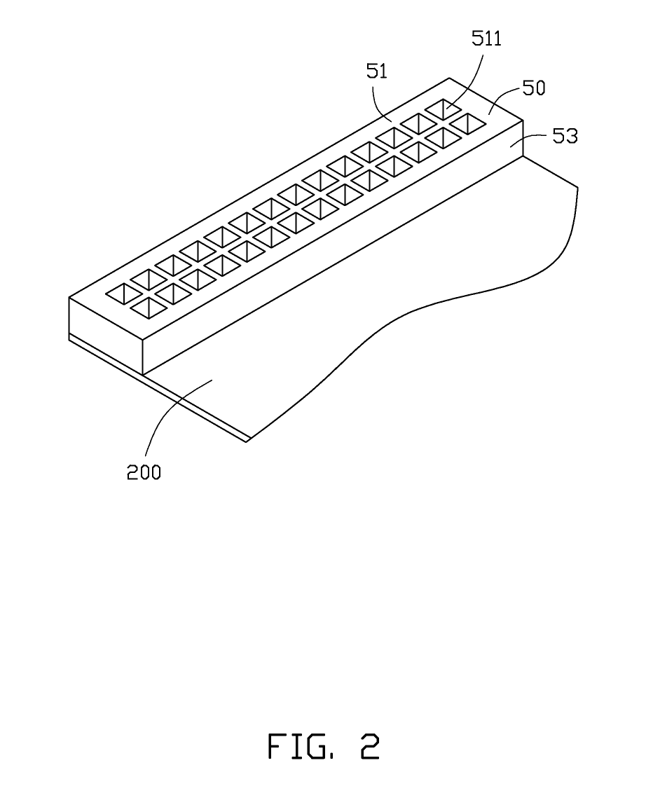

FIGS. 1-2 show an embodiment of an antenna module 100 mounted on a base board 200 of a wireless communication device 400, such as a mobile phone or a personal digital assistant (PDA), to receive and/or send signals. In one embodiment, the base board 200 is a printed circuit board and is mounted inside a housing of the wireless communication device 400. The base board 200 can include a feed point (not shown) and a ground point (not shown) to feed current to the antenna module 100 and provide ground for the antenna module 100, respectively.

The antenna module 100 includes an antenna 10, a plurality of conductive elements 30, a substrate 50, and a connecting element 70.

The antenna 10 can be a planar inverted-F antenna, a monopole antenna, or other suitable antenna. The antenna 10 is secured on the base board 200 and connected to the feed point and the ground point to send and/or receive signals.

The plurality of conductive elements 30 is made of conductive material, such as metal. In this exemplary embodiment, the conductive elements 30 are located on the base board 200 and are adjacent to and surround the antenna 10.

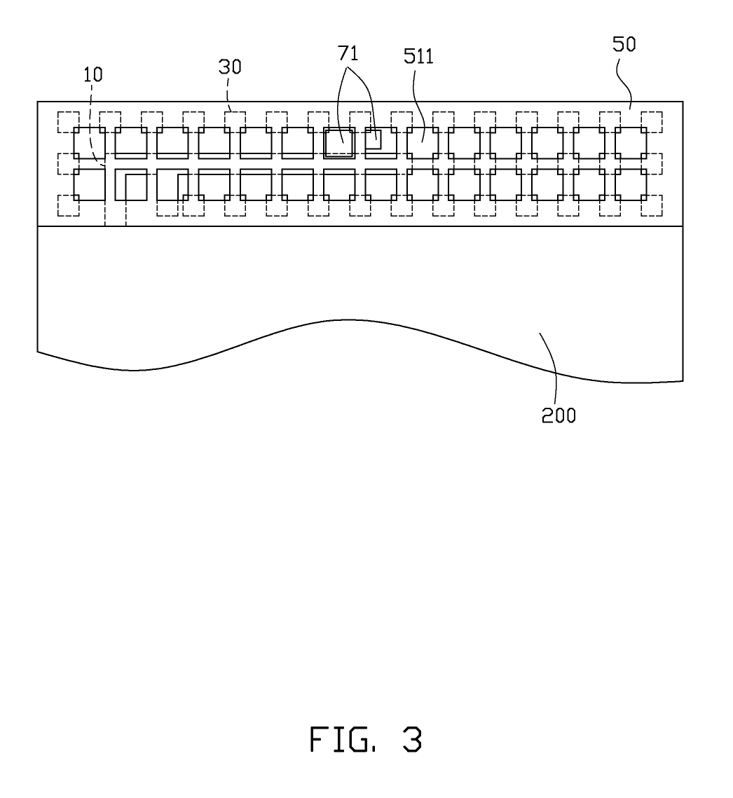

In one embodiment, the substrate 50 is substantially cuboid and made of plastic. The substrate 50 includes a mounting surface 51 and a side surface 53 substantially perpendicular to the mounting surface 51. The mounting surface 51 of the substrate 50 defines a plurality of notches 511 arranged in an N×M matrix array. In this exemplary embodiment, both N and M are integers, and the N×M matrix is a 2×14 matrix. The substrate 50 is positioned over the antenna 10 and the conductive elements 30, such that the antenna 10 and the conductive elements 30 are partially exposed from the notches 511 (see FIG. 3).

In one embodiment, the connecting element 70 is made of conductive material, such as metal. The connecting element 70 can be received in the notches 511 to electronically connect all or some of the conductive elements 30 to the antenna 10. In this way, a current length of the antenna 10 can be changed, thereby adjusting a working frequency of the antenna 10.

The connecting element 70 includes a plurality of connecting blocks 71. Referring to FIG. 3, in this exemplary embodiment, there are two connecting blocks 71. One connecting block 71 is received in one corresponding notch 511 to contact the antenna 10 and two adjacent conductive elements 30. That is, the two conductive elements 30 are electronically connected to the antenna 10 by the connecting block 71. The other connecting block 71 is received in another notch 511 to contact one of the two conductive elements 30 electronically connected to the antenna 10. In this way, the two connecting blocks 71 are electronically connected to each other to make the antenna 10 be electronically connected to the two conductive elements 30, thereby increasing a current length of the antenna 10.

In other embodiments, a number of the connecting blocks 71 received in the notches 511 can be adjusted according to a needed working frequency of the antenna 10. As long as at least one connecting block 71 is electronically connected to one conductive element 30 and the antenna 10, the other connecting blocks 71 can electronically connect another conductive element 30 to the antenna 10, or connect another conductive element 30 to the conductive element 30 already electronically connected to the antenna 10.

To assemble the antenna module 100 into different wireless communication devices, the substrate 50 is secured on the base board 200, such that the conductive elements 30 and the antenna 10 are partially exposed from the notches 511 of the substrate 50. When a working frequency of the antenna 10 needs to be changed, the connecting blocks 71 are received in the corresponding notches 511. Due to the connecting blocks 71 being made of conductive material, the antenna 10 is electronically connected to the conductive elements 30 by the connecting blocks 71 to increase a current length of the antenna 10, and adjust a working frequency of the antenna 10.

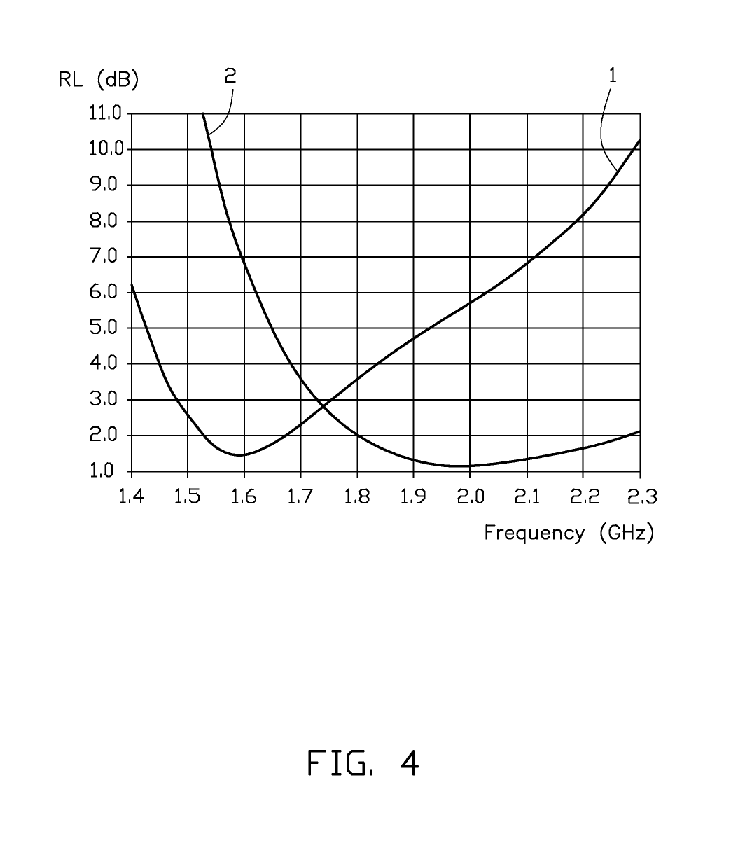

FIG. 4 is a diagram showing a return loss measurement of the antenna module 100. Curve 1 represents a working frequency of the antenna module 100 when the connecting element 70 is received in the notches 511. Curve 2 represents a working frequency of the antenna module 100 when the antenna module 100 has no connecting element 70. As shown in FIG. 4, after the connecting element 70 is received in the notches 511, a central frequency of the antenna 10 can be adjusted from about 1950 megahertz (MHz) to about 1575 MHz.

In addition, table 1 below shows radiation power measurements of the antenna module 100. As shown in table 1, when the connecting element 70 is received in the notches 511, the radiation power of the antenna module 100 is raised to different frequencies.

TABLE 1
Radiation power table comparing performances of an antenna
module of the wireless communication device

| | Radiation power (dB) | |
|---|---|---|
| Frequency | Antenna module without | Antenna module with connecting |
| (MHz) | connecting element | element |
| 1555 | −1.04 | −0.82 |
| 1565 | −0.99 | −0.75 |
| 1575 | −0.96 | −0.70 |
| 1585 | −0.95 | −0.66 |
| 1595 | −0.95 | −0.64 |

Similarly, table 2 below shows radiation efficiency measurements of the antenna module 100. As shown in table 2, when the connecting element 70 is received in the notches 511, the radiation efficiency of the antenna module 100 is also raised to different frequencies.

TABLE 2
Radiation efficiency table comparing performances of
an antenna module of the wireless communication device

| | Radiation efficiency (%) | |
|---|---|---|
| Frequency | Antenna module without | Antenna module with connecting |
| (MHz) | connecting element | element |
| 1555 | 79 | 83 |
| 1565 | 80 | 84 |
| 1575 | 80 | 85 |
| 1585 | 80 | 86 |
| 1595 | 80 | 86 |

In summary, the wireless communication device 400 includes the conductive elements 30 and the connecting element 70, and the connecting element 70 electronically connects the conductive elements 30 to the antenna 10 to adjust a current length of the antenna 10. Thus, working frequencies of the antenna 10 can be easily adjusted, and a matching circuit is not required. Furthermore, a number of the connecting blocks 71 can be changed according to different communication requirements. Thus, a structure or a shape of the antenna 10 does not need to be changed, and a cost of the wireless communication device 400 can be effectively reduced.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in the matters of arrangement of parts within the principles of this disclosure to the full extent indicated by the broad general meaning of the terms in which the appended claims are expressed.

What is claimed is:

1. An antenna module, comprising:
an antenna;
a plurality of conductive elements; and
a connecting element;
wherein the conductive elements and the connecting element are made of conductive material, the conductive elements are adjacent to the antenna, the connecting element allows for the connection of different numbers of the conductive elements to the antenna depending upon the desired working frequency for the antenna.

2. The antenna module of claim 1, further comprising a substrate, wherein the substrate defines a plurality of notches, the substrate is positioned over the antenna and the conductive elements, the antenna and the conductive elements are partially exposed from the notches, the connecting element is received in all or some of notches.

3. The antenna module of claim 2, wherein the substrate is made of plastic.

4. The antenna module of claim 1, wherein the conductive elements are made of metal.

5. The antenna module of claim 1, wherein the connecting element is made of metal.

6. The antenna module of claim 2, wherein the connecting element comprises a plurality of connecting blocks, wherein at least one connecting blocks is electronically connected to one conductive element and the antenna, the other connecting blocks electronically connect another conductive element to the antenna, or connect another conductive element to the conductive element already electronically connected to the antenna.

7. The antenna module of claim 2, wherein the notches arrange in a matrix array in the substrate.

8. A wireless communication device, comprising:
a base board; and
an antenna module positioned on the base board and electronically connected to the base board, the antenna module comprising:
an antenna;
a plurality of conductive elements; and
a connecting element;
wherein the conductive elements and the connecting element are made of conductive material, the conductive elements are adjacent to the antenna, the connecting element allows for the connection of different numbers of the conductive elements to the antenna depending upon the desired working frequency for the antenna.

9. The wireless communication device of claim 8, wherein the antenna module further comprises a substrate, the substrate defines a plurality of notches, the substrate is positioned over the antenna and the conductive elements, the antenna and the conductive elements are partially exposed from the notches, the connecting element is received in all or some of notches.

10. The wireless communication device of claim 9, wherein the substrate is made of plastic.

11. The wireless communication device of claim 8, wherein the conductive elements are made of metal.

12. The wireless communication device of claim 8, wherein the connecting element is made of metal.

13. The wireless communication device of claim 9, wherein the connecting element comprises a plurality of connecting blocks, wherein at least one connecting blocks is electronically connected to one conductive element and the antenna, the other connecting blocks electronically connect another conductive element to the antenna, or connect another conductive element to the conductive element already electronically connected to the antenna.

14. The wireless communication device of claim 9, wherein the notches arrange in a matrix array in the substrate.

15. The wireless communication device of claim 8, wherein the base board is a printed circuit board.
